(19) United States
(12) Patent Application Publication
(10) Pub. No.: US 2013/0263001 A1
(43) Pub. Date: Oct. 3, 2013

(54) RESTRICTING OPERATION OF A CLIENT DEVICE TO PARENT APPROVED CONTENT

(71) Applicants: Andrey Doronichev, London (GB); Waldemar Ariel Baraldi, London (GB); Vytautas Vaitukaitis, London (GB); David Mark Ingram, London (GB); Bogdan Milovan Piloca, London (GB)

(72) Inventors: Andrey Doronichev, London (GB); Waldemar Ariel Baraldi, London (GB); Vytautas Vaitukaitis, London (GB); David Mark Ingram, London (GB); Bogdan Milovan Piloca, London (GB)

(73) Assignee: Google Inc., Mountain View, CA (US)

(21) Appl. No.: 13/438,269

(22) Filed: Apr. 3, 2012

(51) Int. Cl. G06F 3/048

(52) U.S. Cl. 715/719; 715/716

(57) ABSTRACT

This disclosure relates to systems and methods that facilitate restricting operation of a client device to parent approved content.

### TECHNICAL FIELD

This disclosure generally relates to systems and methods that facilitate restricting operation of a client device to parent approved content.

### BACKGROUND

Parents often allow their children to operate a parent's client device in order to keep the child occupied. For example, when a family is out for dinner or taking a long drive, a parent may let a child play with his mobile phone or tablet device so that the child does not get bored or unruly while waiting for food or to arrive at a destination. In another example, a parent may let the child use the parent's personal computer while the parent is working. However, letting a child use a parent's client device can present several issues for the parent and/or child. From the parent's perspective, the child may have access to content that the parent would not like the child to utilize or view. For example, the child may inadvertently access the parent's email or text messaging program and send an inappropriate message to one of the parent's work contacts. In another example, the child may unintentionally access music, videos, or internet sites which have content that is adult oriented. From the child's perspective, she may not be old enough to understand all of the controls of the client device and accidently place the device in a state from which she does not know how to navigate to content she would like to view. For example, a parent may start a video on the client device and give the device to the child. The child may accidentally activate a control that navigates away from the video and have to ask the parent for help to get back to the video. This interruption can become frustrating for the child and parent, especially if occurs repetitively.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the purpose of this summary is to present some concepts related to some exemplary non-limiting embodiments in simplified form as a prelude to more detailed description of the various embodiments that follow in the disclosure.

In accordance with a non-limiting implementation, a content selection component receives playlist input specifying content to include in at least one parent approved playlist. A mode control component selectively enables a child mode on the mobile device based upon mode control input. The child mode prevents all input to the mobile device except for touchscreen input, and displays a child mode interface that restricts access on the mobile device to the at least one parent approved playlist and content associated with the at least one parent approved playlist.

In accordance with another non-limiting implementation, a playlist input specifying content to include in at least one parent approved playlist is received. A child mode on the mobile device is selectively enabled based upon mode control input, wherein child mode prevents all input to the device except for touchscreen input, and displays a child mode interface that restricts access on the mobile device to the at least one parent approved playlist and content in the at least one parent approved playlist.

These and other implementations and embodiments are described in more detail below.

### BRIEF DESCRIPTION OF THE DRAWINGS

FIG. 1 illustrates a block diagram of an exemplary non-limiting system that allows a parent to control interaction with a client device and specify content approved for a child to view on the client device in accordance with an implementation of this disclosure.

FIG. 2A illustrates an exemplary non-limiting display of a user interface for managing content on a client device in accordance with an implementation of this disclosure.

FIG. 2B illustrates an exemplary non-limiting display of a user interface for editing a playlist in accordance with an implementation of this disclosure.

FIG. 2C illustrates an exemplary non-limiting display of a user interface for associating a background image to a playlist in accordance with an implementation of this disclosure.

FIG. 2D illustrates an exemplary non-limiting display of a user interface for creating a new playlist in accordance with an implementation of this disclosure.

FIG. 2E illustrates an exemplary non-limiting display of a user interface for auto building a playlist from parent approved content in accordance with an implementation of this disclosure.

FIG. 2F illustrates an exemplary non-limiting display of a user interface for editing a parent approved content list in accordance with an implementation of this disclosure.

FIG. 2G illustrates an exemplary non-limiting display of a user interface for editing a parent approved content list based upon automatically suggested content in accordance with an implementation of this disclosure.

FIG. 3A illustrates an exemplary non-limiting display of a child mode interface for selecting parent approved playlists or content for viewing in accordance with an implementation of this disclosure.

FIG. 3B illustrates an exemplary non-limiting display of a child mode interface for showing an animation while preparing content for viewing in accordance with an implementation of this disclosure.

FIG. 3C illustrates an exemplary non-limiting display of a child mode interface for viewing parent approved content in accordance with an implementation of this disclosure.

FIG. 4 illustrates an exemplary non-limiting flow diagram for configuring a parent approved playlist in accordance with an implementation of this disclosure.

FIG. 5 illustrates an exemplary non-limiting flow diagram for configuring a parent approved content list in accordance with an implementation of this disclosure.

FIG. 6 illustrates an exemplary non-limiting flow diagram for enabling and disabling child mode in accordance with an implementation of this disclosure.

FIG. 7 illustrates an exemplary non-limiting flow diagram for customizing mode control input for enabling or disabling child mode in accordance with an implementation of this disclosure.

FIG. 8 is a block diagram representing an exemplary non-limiting networked environment in which the various embodiments can be implemented.

FIG. 9 is a block diagram representing an exemplary non-limiting computing system or operating environment in which the various embodiments can be implemented.

### DETAILED DESCRIPTION

### Overview

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of this disclosure may be practiced without these specific details, or with other methods, components, materials, etc. In other instances, well-known structures and devices are shown in block diagram form to facilitate describing this disclosure.

In accordance with various disclosed aspects, a mechanism is provided for allowing the parent to control content that a child can access and limiting operation of a client device when the parent places the client device in a child mode. Advantageously, the child cannot accidentally access content that the parent has not approved and the child can operate the device without having to ask the parent for assistance. For example, a parent can designate content that is approved for the child to access, and upon placing the client device in a child mode, the user interface will restrict access to the approved content, as well as, disabling controls not required to view the content.

Content can include, for example, video, audio, image, text, or any combination thereof, non-limiting examples of which include, music, speeches, cartoons, short films, movies, televisions shows, documents, books, magazines, articles, novels, quotes, poems, comics, advertisements, photos, posters, prints, paintings, artwork, graphics, games, applications, or any other creative work that can be captured and/or conveyed through video, audio, image, text, or any combination thereof. In a non-limiting example, a social networking application may contain video or photo content that users have uploaded to share. In another non-limiting example, a music application can contain music available for listening. A further non-limiting example is an education site that contains a combination of text articles, videos, photos, and audio recordings. In another example, a tablet device may have game applications available for playing. Furthermore, the content can be available on an intranet, internet, or can be local content.

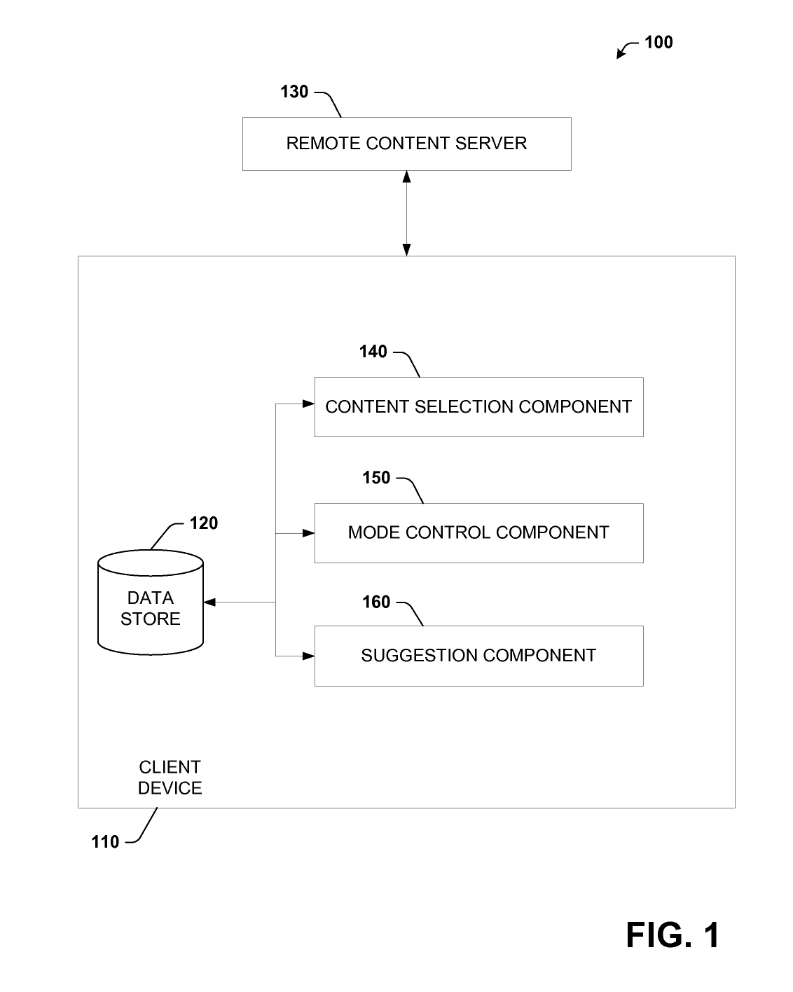

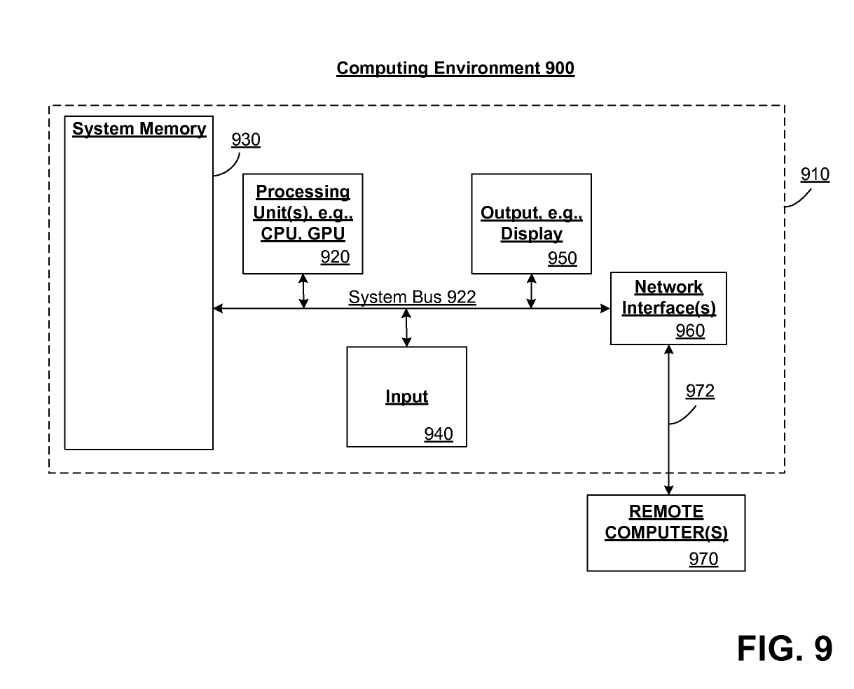

Referring now to the drawings, FIG. 1 depicts a system 100 that allows a parent to control interaction with a client device 110 and specify content approved for a child to view on client device 110. System 100 includes a remote content server 130 that provides content to client device 110 remotely. In addition, client device 110 can access content stored locally, for example, in data store 120. Furthermore, client device 110 can receive input from a user to control interaction with and presentation of content, for example, using input devices, non-limiting examples of which can be found with reference to FIG. 9.

Client device 110 includes a memory that stores computer executable components and a processor that executes computer executable components stored in the memory, a non-limiting example of which can be found with reference to FIG. 9. Client device 110 can communicate via a network to remote content server 130. It is to be appreciated that while only one remote content server 130 is depicted, client device 110 can communicate with a plurality of remote content servers 130 concurrently.

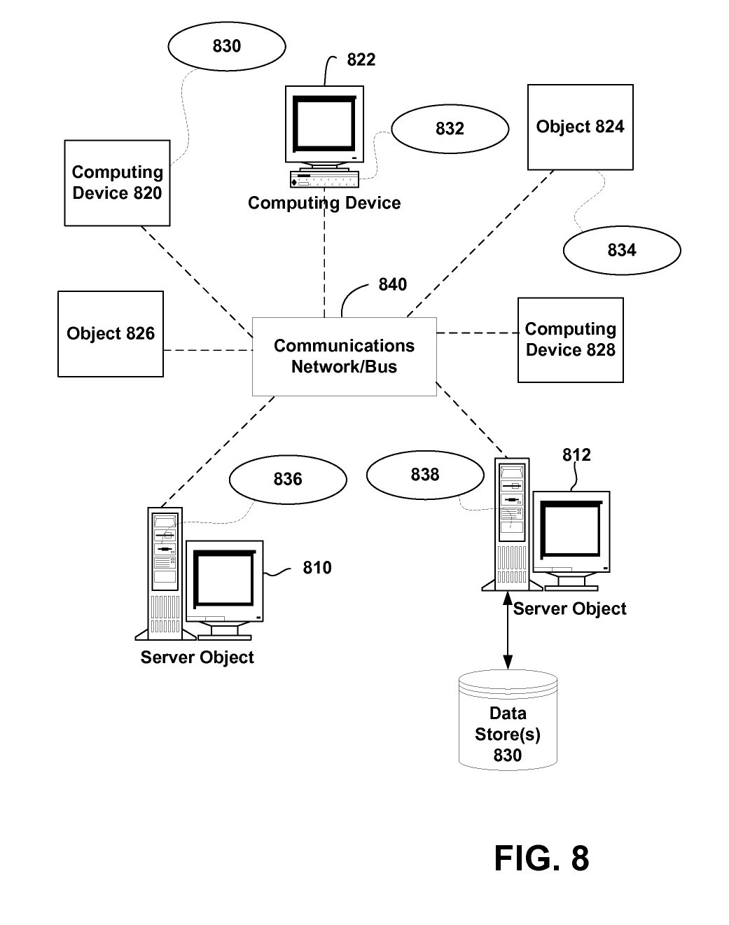

Client device 110 includes a content selection component 140 that allows for specifying content that is approved for child viewing on client device 110. Client device 110 further includes a mode control component 150 that enables and disables a child mode on client device 110. In addition, client device 110 includes a suggestion component 160 that provides content recommendations for parent approval. Additionally, client device 110 includes a data store 120 that can store content, as well as, data generated by content selection component 140, mode control component 150, or suggestion component 160. Data store 120 can be stored on any suitable type of storage device, non-limiting examples of which are illustrated with reference to FIGS. 8 and 9.

Client device 110 can be any suitable type of device for interacting with content locally, or over a wired or wireless communication link, non-limiting examples of which include, a mobile device, a mobile phone, personal data assistant, laptop computer, tablet computer, desktop computer, server system, cable set top box, satellite set top box, cable modem, television set, media extender device, blu-ray device, DVD (digital versatile disc or digital video disc) device, compact disc device, video game system, audio/video receiver, radio device, portable music player, navigation system, car stereo, etc. Moreover, client device 110 can include a user interface (e.g., a web browser or application), that can receive and present displays and generated locally or remotely.

With continued reference to FIG. 1, content selection component 140 provides a user interface for a parent to specify content that is approved for a child to view on client device 110. While examples herein refer to a video application and associated video content, it is to be appreciated that any application on client device 110 for interacting with content is applicable. Furthermore, an application or operating system that provides for viewing a mix of content types is also applicable. For example, a user can define a playlist, in an application or at the operating system that includes, music, games, videos, educational tools, photos, books, and/or other content that are acceptable for a child to view.

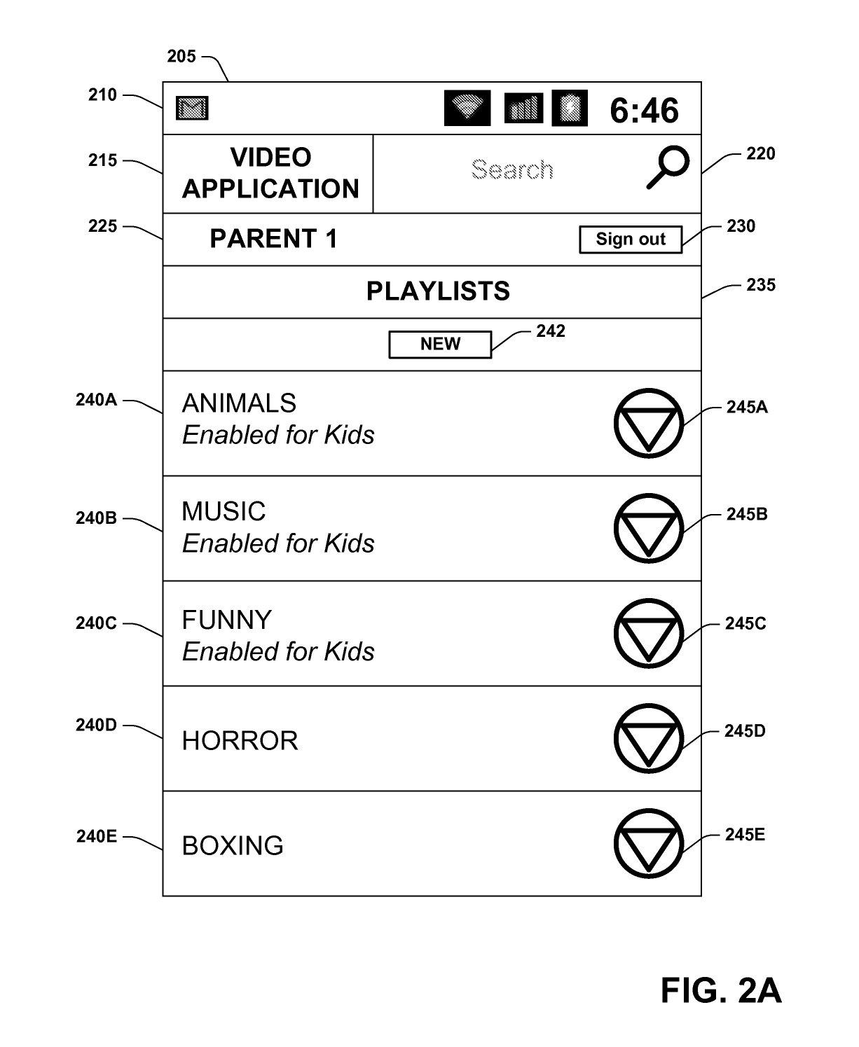

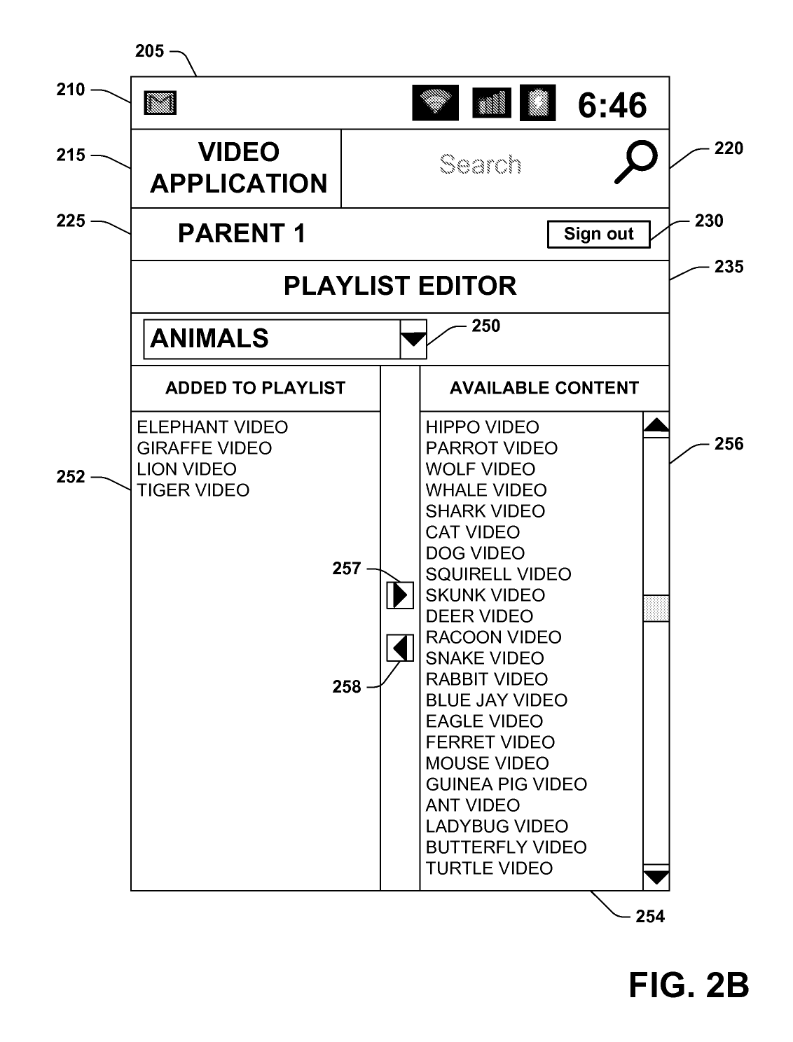

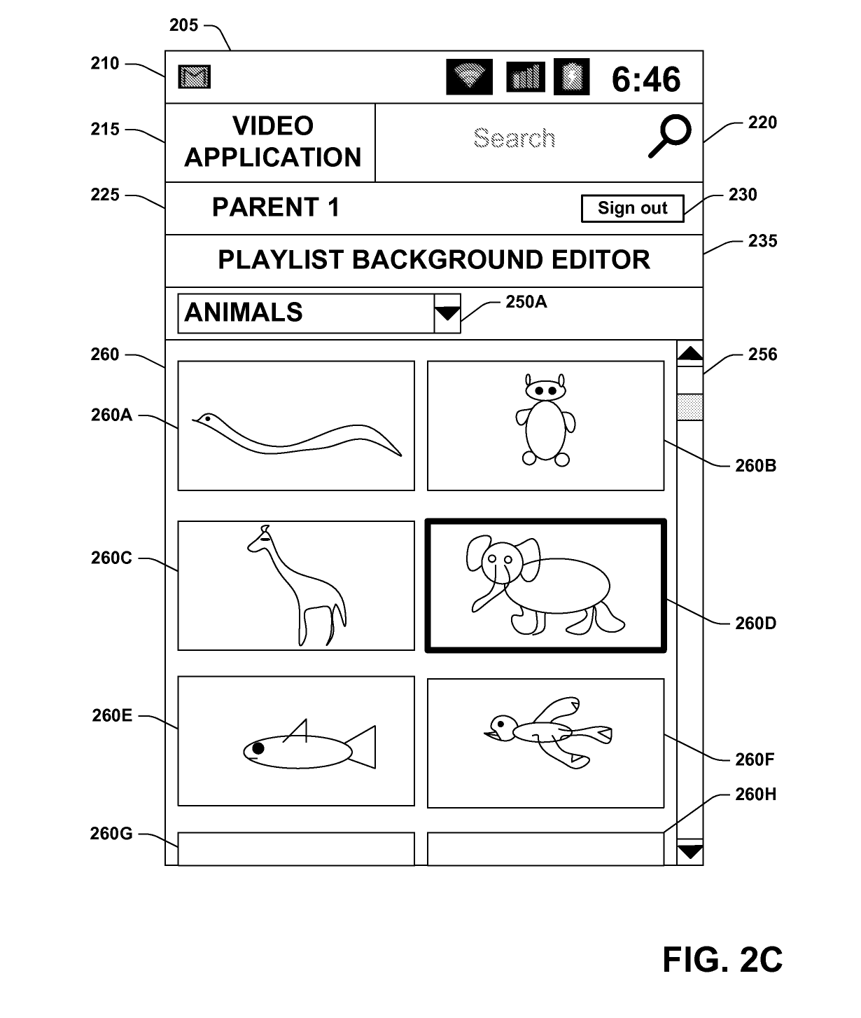

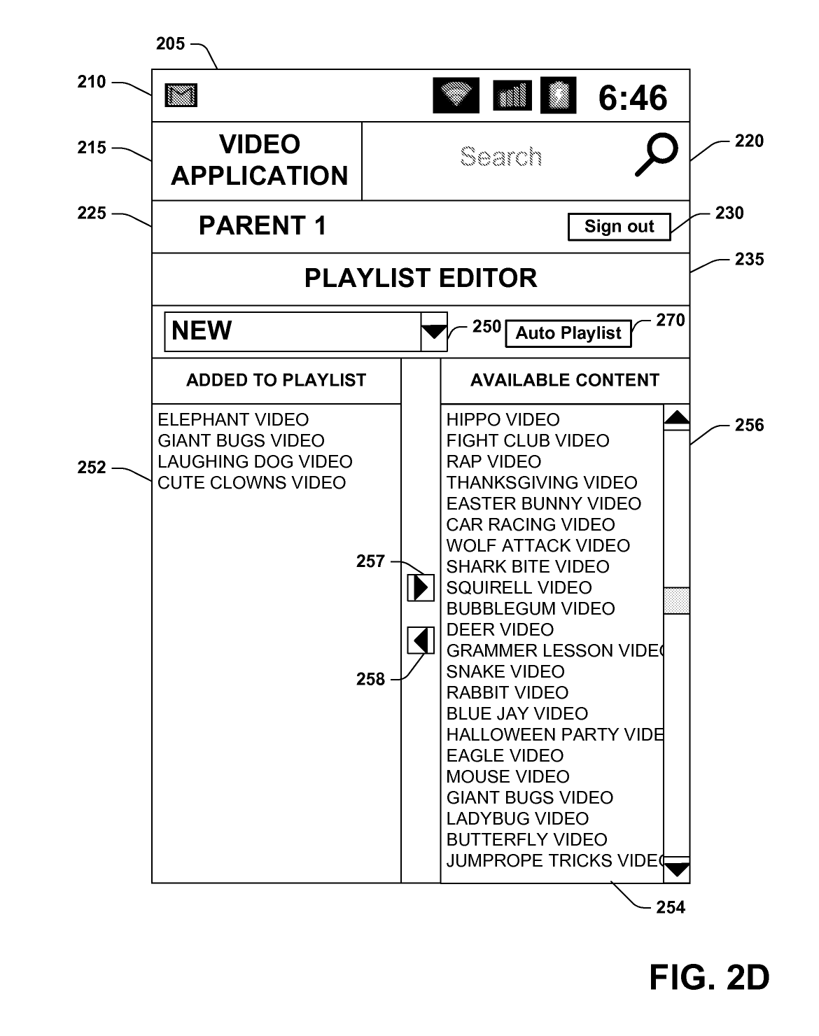

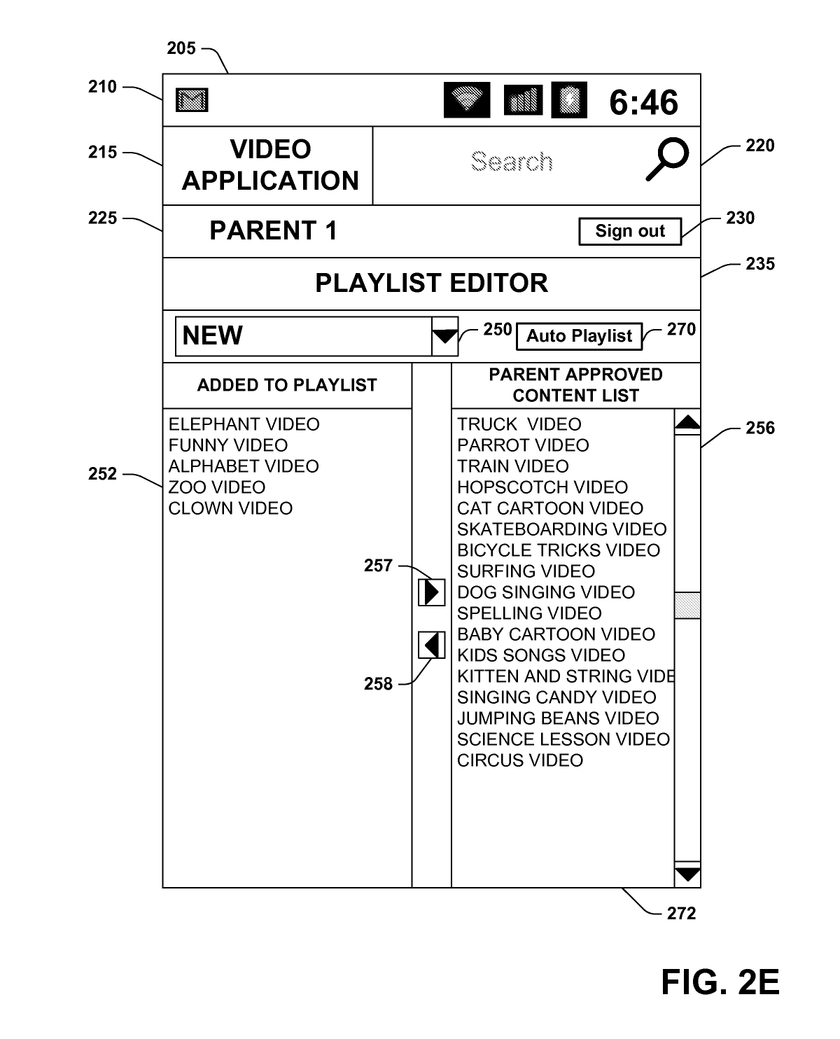

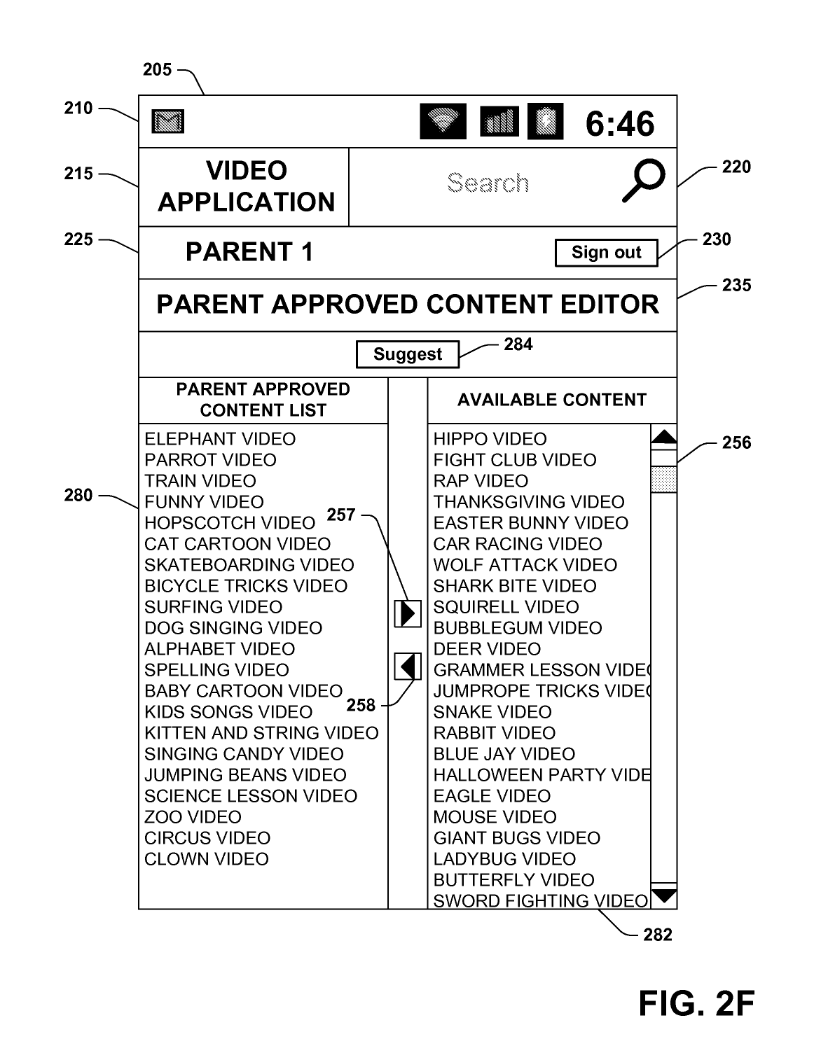

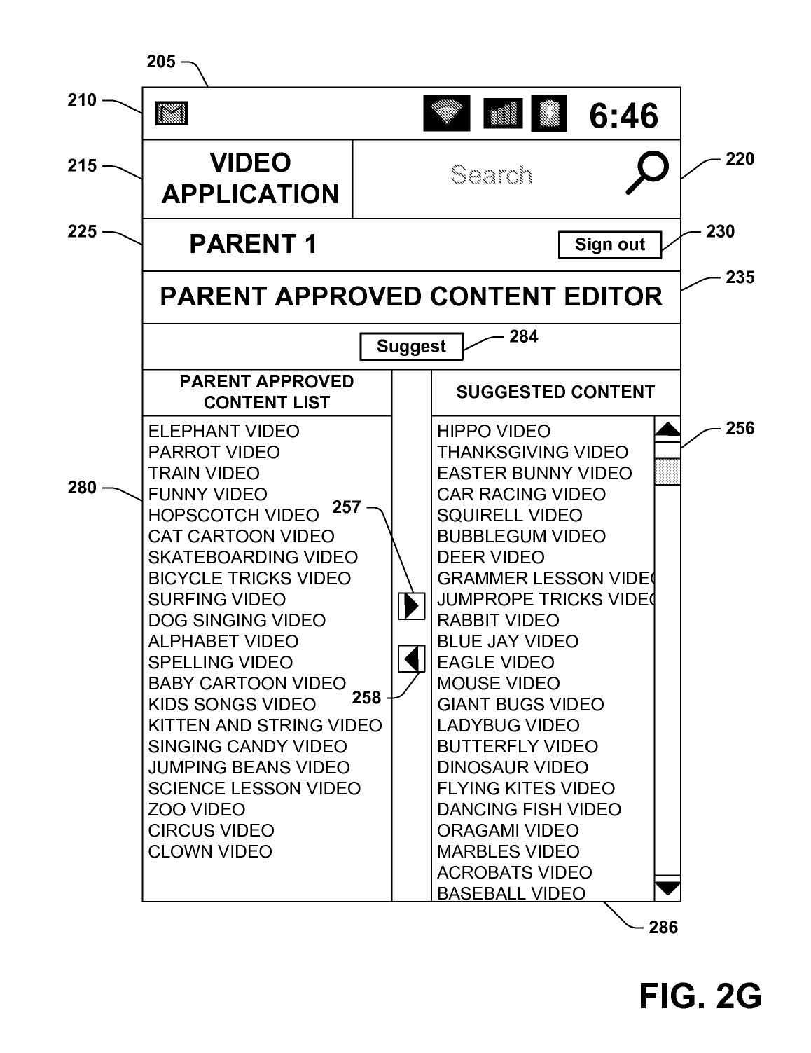

Referring to FIG. 2A, is depicted a non-limiting example user interface 205 on client device 110 presented by content selection component 140. User interface 205 includes a notification area 210 that provides notification to the user using graphics or text. Additionally, user interface 205 includes an application title area 215 that indicates the application currently active or in the foreground of the user interface, which in this example is a “VIDEO APPLICATION”. User interface 205 also includes a search area 220 that allows for entering a search for content in the “VIDEO APPLICATION”. Furthermore, user interface 205 includes a user area 225 that indicates the current user signed into the video application, which in this example is “PARENT 1”, and that also provides a sign-out selection element 230 for the user to sign out of the application. User interface 205 further includes a function title area 235 that indicates a current functional area of the application, which in this non-limiting example is “PLAYLIST” representing a function for managing a list of playlists. In this example, “ANIMALS” 240A, “MUSIC” 240B, “FUNNY” 240C, “HORROR” 240D, and “BOXING” 240E playlists are depicted along with respective selection elements 245A-E to allow a user to select an action to perform with the associated playlist, for example, by a menu that is activated upon selection of selection elements 245A-E. It is to be appreciated that while only five playlists are depicted, any number of playlists can be included. Furthermore, navigation elements can be included for navigating the list of playlists, non-limiting examples of which include a scrolling element or touchscreen swipe gesture navigation. Actions can include, but are not limited to, playing the playlist, editing the playlist, marking the playlist as enabled or disabled for children, or selecting a background image for the playlist. In this non-limiting example, “PARENT 1” has enabled “ANIMALS” 240A, “MUSIC” 240B, and “FUNNY” 240C playlists for viewing by children (parent approved playlist), as depicted by the text “Enabled for Kids” associated with these playlists. User interface 205 also includes a new playlist selection element 242 that presents a playlist editor for creating a new playlist. Content selection component 140 can store any selections or entries made by the user using user interface 205.

Referring to FIG. 2B in a non-limiting example, user interface 205 is depicted where “PARENT 1” has selected “ANIMALS” 240A playlist for editing. Correspondingly, function title area 235 indicates the current functional area of the application as “PLAYLIST EDITOR”. User interface 205 further includes a playlist selection menu 250 that allows for selection of a playlist for editing, this example depicting “ANIMALS” associated with “ANIMALS” 240A playlist. For example, playlist selection menu 250 can be a drop down menu that includes a list of the playlists previously created. In addition, playlist selection menu 250 can include a selectable entry for creating a new playlist. User interface 205 also includes an added to playlist area 252 that shows content that is currently in the playlist selected in playlist selection menu 250. In this non-limiting example, added to playlist area 252 shows “ELEPHANT VIDEO . . . TIGER VIDEO” currently in “ANIMALS” 240A playlist.

User interface 205 includes an available content area 254 that shows content that is available to be added to the playlist selected in playlist selection menu 250. It is to be appreciated that available content can be content that is stored locally on client device 110 or remotely on remote content server 130. In this example, available content area 254 shows “HIPPO VIDEO . . . TURTLE VIDEO” available to be added to “ANIMALS” 240A playlist. In addition, the user can narrow the list of available content by entering a query in search area 220, results of which would appear in available content area 254. User interface 205 includes a scrolling control element 256 for navigating the list of available content in available content area 254. It is to be understood that added to playlist area 252 can also include a scrolling control element 256 for navigating the list of content in a playlist.

User interface 205 includes a remove content selection element 257 for moving content from the list on the left to the list on the right, in this example, moving content from the added to playlist area 252 to the available content area 254. User interface 205 also includes an add content selection element 258 for moving content from the list on the right to the list on the left, in this example, moving content from the available content area 254 to the added to playlist area 252. For example, “PARENT 1” can use add content selection element 257 and remove content selection element 257 to configure the content included in a playlist (playlist input). The configured playlist can be stored by content selection component 140, for example, automatically upon the user navigating away from the “PLAYLIST EDITOR” function, upon the user selecting a save playlist selection element (not depicted), the user performing a specific gesture, or by any other suitable mechanism for storing a playlist.

Referring to FIG. 2C in a non-limiting example, user interface 205 is depicted where “PARENT 1” has chosen “ANIMALS” 240A playlist for selecting a background image to associate. Therefore, function title area 235 indicates the current functional area of the application as “PLAYLIST BACKGROUND EDITOR”. User interface 205 further includes a playlist selection menu 250A that allows for selection of a playlist for background image editing, this example depicting “ANIMAL” associated with “ANIMALS” 240A playlist. Playlist selection menu 250A can be similar to playlist selection menu 250, however, may or may not include an entry for creating a new playlist. User interface 205 includes a background image selection area 260 that allows a user to select an image for the playlist selected in playlist selection menu 250A. The background image can be displayed in a child mode interface 305 presented in child mode to represent the playlist, so a child can more easily identify the content of the playlist. In this non-limiting example, images 260A, 260B, 260C, 260D, 260E, 260F, 260H are listed in background image selection area 260. While eight images are depicted in the example, it is to be understood that any suitable number of images can be presented in background image selection area 260 with suitable navigation, for example, scrolling control element 256. Images 260A, 260B, 260C, 260D, 260E, 260F, 260H can be generated by content selection component 140 from images included within or associated with content included in the playlist. For example, images can be frames within video content or images provided in metadata associated with video content. In another example, an image can be an album cover picture in metadata associated with music content. In a further example, an image can be an icon picture associated with or images within a game. Furthermore, this example, depicts “PARENT 1” having selected image 260D as the background image as shown by the thicker border surrounding image 260D (playlist input). It is to be understood that any suitable mechanism for selection of and depicting the currently selected image can be employed. For example, the currently selected background image can be identified by text, an icon, color, brightness, or any other visual indication.

Association of the selected background image with the respective playlist can be stored by content selection component 140, for example, automatically upon the user navigating away from the “PLAYLIST BACKGROUND EDITOR” function, upon the user selecting a save playlist background image selection element (not depicted), the user performing a specific gesture, or by any other suitable mechanism for storing an association of a background image with a playlist. It is to be further appreciated that content selection component 140 can automatically select an image as a background image to associate with a playlist. For example, based upon an analysis of the content in a playlist, content selection component 140 can select an image for the playlist that represents the content, for example, based upon criteria predetermined by the system or specified by a user, such as in a user profile. In non-limiting example, criteria can be an image that represents the majority of the content, an image associated with the first content in the playlist, collage of images from the content, or any other criteria. In a further non-limiting example, content selection component can analyze the content of the playlist and determine that a majority of the content is associated with animals and select an animal picture from the content as a background image for the playlist. It is to be appreciated that associating a background image to a playlist can be optional.

Referring to FIG. 2D in a non-limiting example, user interface 205 is depicted where “PARENT 1” has selected new playlist selection element 242 from FIG. 2A or new playlist entry from playlist selection menu 250 of FIG. 2B to create a new playlist. Function title area 235 indicates the current functional area of the application as “PLAYLIST EDITOR”, similar to that depicted in FIG. 2B. User interface 205 further includes a playlist selection menu 250 that allows for selection of a playlist for editing, this example depicting “NEW” associated with “creating a new playlist. Playlist selection menu 250 can accept input of a name for the playlist, for example, entered in place of “NEW” directly on the drop down menu. However, any suitable mechanism for entering a name for the playlist can be employed. User interface 205 also includes an added to playlist area 252 that shows content that is currently in the playlist selected in playlist selection menu 250. In this non-limiting example, added to playlist area 252 shows “ELEPHANT VIDEO . . . CUTE CLOWNS VIDEO” currently in “NEW” playlist.

User interface 205 includes an available content area 254 that shows content that is available to be added to the playlist selected in playlist selection menu 250. In this example, shows “HIPPO VIDEO . . . JUMPROPE VIDEO” available to be added to “NEW” playlist. In addition, the user can narrow the list of available content by entering a query in search area 220, results of which would appear in available content area 254. Furthermore, “PARENT 1” can use add content selection element 257 and remove content selection element 257 to configure the content included in “NEW” playlist (playlist input). The configured playlist can be stored by content selection component 140. Additionally, user interface 205 includes auto playlist selection element 270 for automatically adding content to a “NEW” playlist, for example, as depicted in FIG. 2E.

Referring to FIG. 2E in a non-limiting example, user interface 205 is depicted where “PARENT 1” has selected auto playlist selection element 270 from FIG. 2D to automatically add content to a “NEW” playlist. Function title area 235 indicates the current functional area of the application as “PLAYLIST EDITOR”, similar to that depicted in FIGS. 2B and 2D. User interface 205 further includes a playlist selection menu 250 that allows for selection of a playlist for editing, this example depicting “NEW” associated with “creating a new playlist. Playlist selection menu 250 can accept input of a name for the playlist, for example, entered in place of “NEW” directly on the drop down menu. However, any suitable mechanism for entering a name for the playlist can be employed.

User interface 205 also includes an added to playlist area 252 that shows content that is currently in the playlist selected in playlist selection menu 250. In this non-limiting example, added to playlist area 252 shows “ELEPHANT VIDEO . . . CLOWN VIDEO” currently in “NEW” playlist which were automatically added to the playlist by suggestion component 160 (playlist input) in response to selection of auto playlist selection element 270 from FIG. 2D or FIG. 2E. User interface 205 includes a parent approved content list 272 that shows content that “PARENT 1” has approved for viewing by children and which can be added to the playlist selected in playlist selection menu 250. In this example, parent approved content list 272 shows “TRUCK VIDEO . . . CIRCUS VIDEO” available to be added to “NEW” playlist.

Referring back to FIG. 1, suggestion component 160 can automatically add content to the playlist by employing artificial intelligence to analyze playlists, content, parent approved content list, logs of previous parent or child interaction with the client device, or other criteria. For example, suggestion component 160 can examine content that “PARENT 1” has added to other playlists and create a playlist with similar content from the parent approved content list based upon an analysis of content in the other playlists or metadata associated with content in the other playlists. In another example, suggestion component 160 can examine content that a child has viewed while client device 110 is in child mode and create a playlist with similar content from the parent approved content list based upon an analysis of the content the child has viewed or metadata associated with the content the child has viewed. In this example, suggestion component 160 selects content from the parent approved content list 272 to add to the new playlist, in order to automatically build a parent approved playlist. As such, in one example, the new parent approved playlist can automatically be set as “Enabled for Kids” by content selection component 140.

In another example, the new parent approved playlist may require manual setting as “Enabled for Kids” in order to give the parent complete control over which playlists are approved for their children (playlist input). Advantageously, suggestion component 160 can learn preferences of a parent and/or child and automatically build playlists according to their preferences. In a non-limiting example, suggestion component 160 can employ user preferences stored in a user profile and/or inferred by monitoring user interaction with the client device 110 to determine content of interest to a user. For example, past interaction with content can indicate a user's interest in particular content. In another example, user profiles for a user and/or friends of a user can provide preference settings or stored inferences of content that is of interest to a user. For example, parents can share or recommend content for children's viewing to their friends.

Suggestion component 160 can determine content that is likely to be of interest to a user by examining logs storing user interaction with content, non-limiting examples or which include, searches, navigation of a content, viewing content, browsing content, rating content, like indication of content, dislike indication of content, and/or comments or annotations applied to content. It is to be appreciated that any criteria can be employed for determining which content may be of interest to a user.

Continuing with reference to FIG. 2E, the user can narrow the parent approved content list 272 by entering a search in search area 220, results of which would appear in parent approved content list 272. Additionally, “PARENT 1” can use add content selection element 257 and remove content selection element 257 to configure the content included in “NEW” playlist (playlist input). For example, the parent can remove one or more content from the “NEW” playlist that was automatically added by suggestion component 160 or add content that was not suggested by suggestion component 160. The configured playlist can be stored by content selection component 140.

Referring to FIG. 2F in a non-limiting example, user interface 205 is depicted where “PARENT 1” has navigated to a parent approved content editor using a suitable user interface navigation mechanism. Function title area 235 indicates the current functional area of the application as “PARENT APPROVED CONTENT EDITOR”. User interface 205 includes a parent approved content list 280, similar to parent approved content list 272 of FIG. 2E, that shows content that is currently in the parent approved content list 280. In this non-limiting example, “ELEPHANT VIDEO . . . CLOWN VIDEO” are currently in the parent approved content list 280. User interface 205 also includes an available content area 282 that shows content that is available to be added to the parent approved content list 280. In this example, available content area 282 shows “HIPPO VIDEO . . . SWORD FIGHTING VIDEO” visible to be added the parent approved content list 280. It is to be appreciated that additional content may be available that is not currently visible in the available content list, but can be shown using scrolling control element 256. “PARENT 1” can use add content selection element 257 and remove content selection element 257 to configure the content included in the parent approved content list 280 (parent approved content input). The configured parent approved content list 280 can be stored by content selection component 140. Furthermore, user interface 205 includes suggest selection element 284 for automatically generating a list of suggested content, for example, as depicted in FIG. 2G.

Referring to FIG. 2G in a non-limiting example, user interface 205 is depicted where “PARENT 1” has selected suggest selection element 284 from FIG. 2F to automatically generate a list of suggested content. Function title area 235 indicates the current functional area of the application as “PARENT APPROVED CONTENT EDITOR”. User interface 205 includes a parent approved content list 280, that shows content that is currently in the parent approved content list 280. In this non-limiting example, “ELEPHANT VIDEO . . . CLOWN VIDEO” are currently in the parent approved content list 280. User interface 205 also includes a suggested content list 286 that shows content by suggestion component 160 that is available to be added to the parent approved content list 280. In this example, suggested content list 286 shows “HIPPO VIDEO . . . BASEBALL VIDEO” visible to be added the parent approved content list 280. It is to be appreciated that additional content may be available that is not currently visible in the available content list, but can become visible using scrolling control element 256.

Suggestion component 160 can automatically add content to the suggested content list 286 by employing artificial intelligence to analyze playlists, content, parent approved content list, logs of previous parent or child interaction with the client device, or other criteria. For example, suggestion component 160 can examine content that “PARENT 1” has added to other playlists identify similar available content to add to the suggested content list 286 based upon an analysis of content in the other playlists or metadata associated with content in the other playlists.

In another example, suggestion component 160 can examine content that a child has viewed while client device 110 is in child mode and identify similar available content to add to the suggested content list 286 based upon an analysis of the content the child has viewed or metadata associated with the content the child has viewed. “PARENT 1” can use add content selection element 257 and remove content selection element 257 to configure the content included in the parent approved content list 280 (parent approved content input). The configured parent approved content list 280 can be stored by content selection component 140. In this example, suggestion component 160 is depicted adding content to a suggested content list 286, and not directly to the parent approved content list 280. Advantageously, this gives the parent complete control over the content that is in the parent approved content list 280. However, suggestion component 160 can add suggested content directly to the parent approved content list 280 (parent approved content input), for example, based upon a preference set by a parent in a parent profile.

Referring back to FIG. 1, mode control component 150 enables and disables a child mode on client device 110 based upon a mode control input. In a non-limiting example, a specific gesture input can enable or disable child mode, such as touching four corners of a touchscreen interface. In another example, a biometric input can enable or disable child mode based upon recognition of biometric input from a specific user, such as a parent. However, any suitable mechanism for providing mode control input can be employed. Mode control component 150 can allow a parent to define the mode control input that enables or disables child mode, for example, such that their child will not be able perform the mode control input or so that the parent can adjust the mode control input if their child has learned the mode control input (mode control customization input).

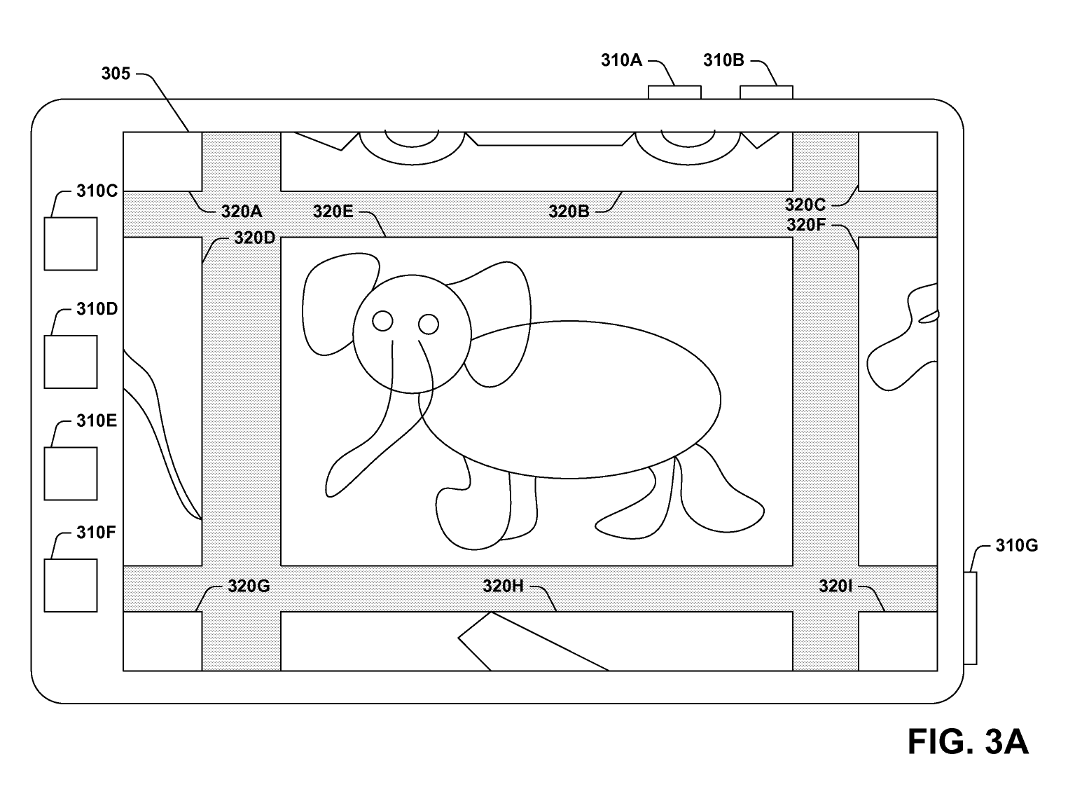

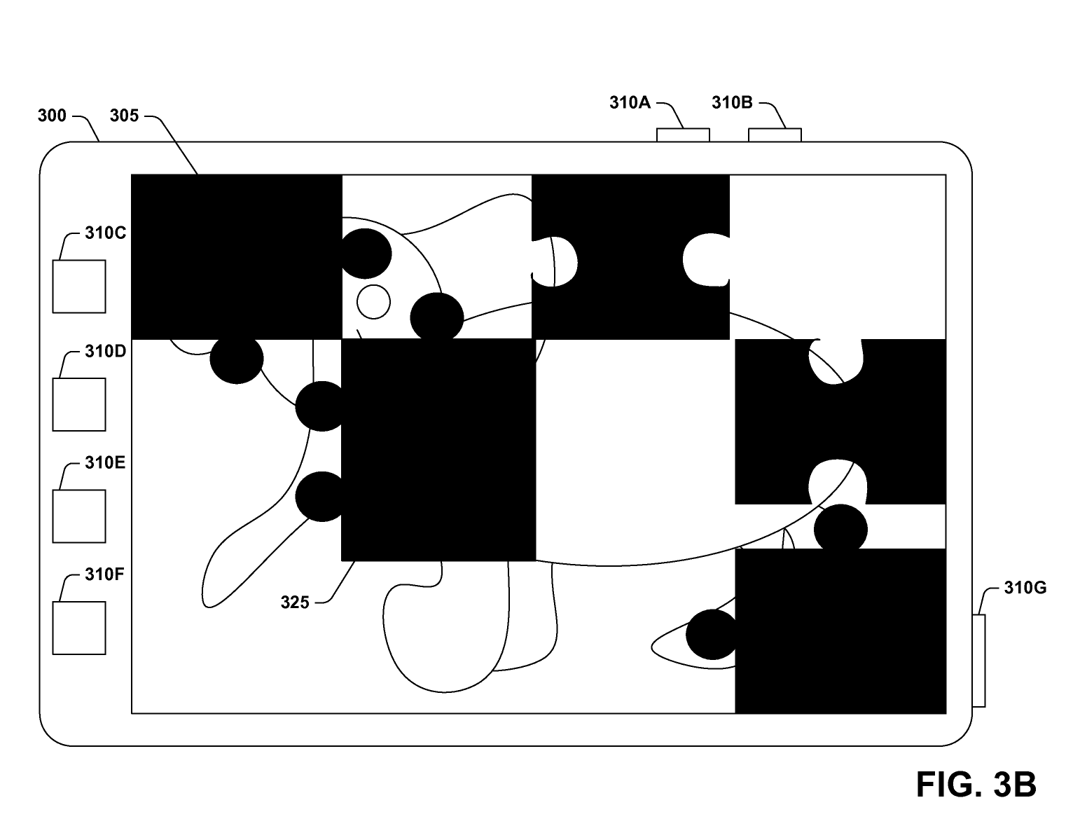

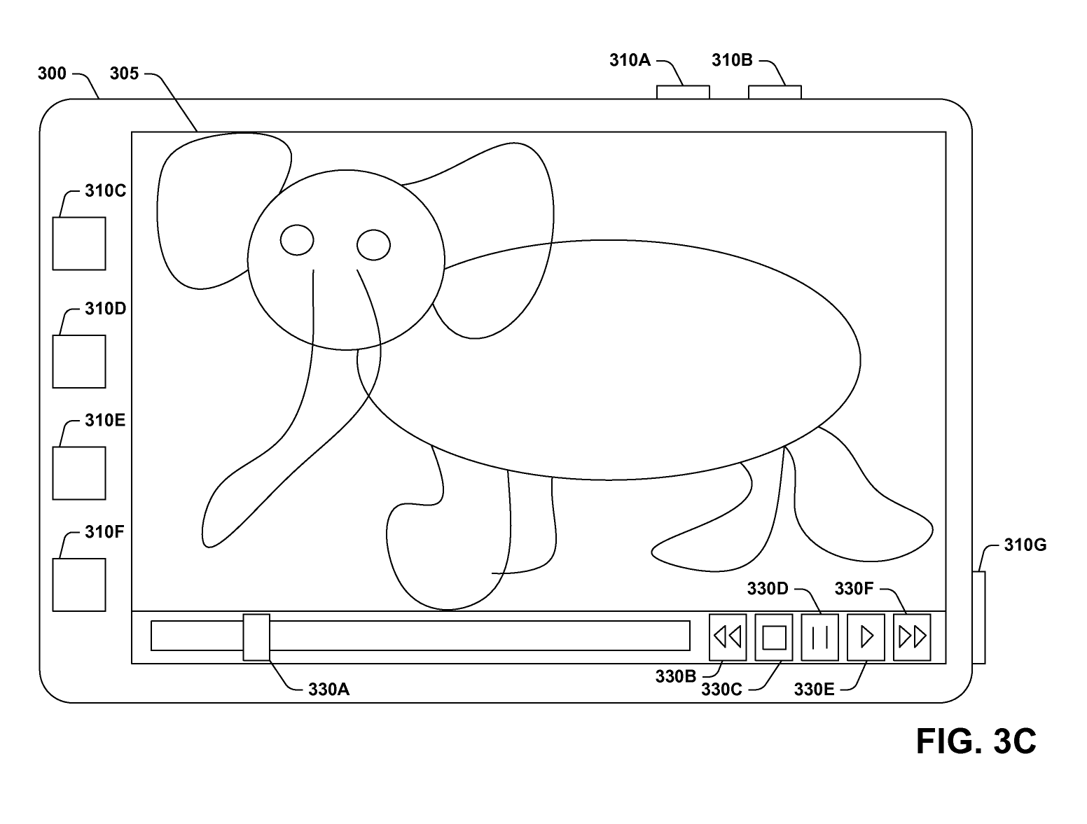

In a non-limiting example, a parent can define or modify a touchscreen gesture or biometric input for enabling or disabling child mode. The mode control input is configured such that a child is unable to or it is difficult for the child to perform the mode control input, so they cannot disable the child mode when they are using client device 110. In response to receiving mode control input specifying to enable child mode, mode control component 150 can enter child mode and present a child mode interface 305, such as depicted in FIGS. 3A-C and disable all user inputs on the device except a touchscreen interface, and optionally biometric interfaces, for example, if biometrics inputs are used for enabling and disabling child mode. Furthermore, biometric inputs can be filtered to only accept input from a parent. For example, if speech recognition is employed to enable to disable child mode, a microphone can remain enabled in child mode and can be configured to only accept input from a recognized parent, such that the child is limited to the touchscreen interface. In another example, all inputs to the device can be disabled except a touchscreen interface, such as, camera, microphone, physical buttons on the device, non-limiting examples of which include power button, volume control button, camera button, menu button, home button, search button, back button, keyboard, joystick, mouse stick, trackball, or any other physical button on client device 110. In general, client device 110 in child mode is configured such that a child can only interact with the device through a touchscreen interface and the child can only navigate within child mode interface 305.

Referring to FIG. 3A in a non-limiting example, client device 110 with child mode interface 305 is depicted. Child mode interface 305 restricts the device to applications, content, or functions that are approved by the parent for the child. In this manner, a child will not be able to accidentally perform an operation on the device that is not approved by the parent, such as sending an e-mail to the parent's co-worker or getting the client device 110 in a state where they cannot navigate to content that they would like to view. For example, physical input buttons, such as 310A, 310B, 310C, 310D, 310E, 310F, and 310G can be disabled. It is to be appreciated that a child cannot modify parent approved playlists or parent approved content lists in the child mode interface. Furthermore, child mode interface 305 is a simplified interface that limits navigation in a manner that is easy for a child to employ. For example, only background images can be displayed, or only text can be displayed, or a combination of background images and text can be display, such as name of playlist or content associated with the background image. It is to be appreciated that the child mode interface can employ any combination of visual and/or audio elements. In a non-limiting example, child mode interface 305 shows background images 320A, 320B, 320C, 320D, 320E, 320F, 320G, 320H, and 320I associated with respective parent approved playlists. It is to be understood that while nine background images are displayed, any number of background images can be included in child mode interface 305 and displayed using suitable navigation controls. A child can navigate amongst the background images 320A, 320B, 320C, 320D, 320E, 320F, 320G, 320H, and 320I, for example, using touchscreen swipe navigation. For example, swiping down can bring background image 320B to the center of the display, swiping up can bring background image 320H to the center of the display, swiping left can bring background image 320F to the center of the display, or swiping right can bring background image 320D to the center of the display, and likewise swiping in a diagonal direction can bring a respective background image 320A, 320C, 320G, or 320I to the center of the display depending on the direction of the diagonal swipe.

It is to be appreciated, that while this example presents background images 320A, 320B, 320C, 320D, 320E, 320F, 320G, 320H, and 320I as associated with respective parent approved playlists, said background images can be associated with parent approved content, or a mix of parent approved content and parent approved playlists. In one non-limiting example, each horizontal row of background images represents parent approved content in an associated parent approved playlist. Swiping up or down navigates amongst parent approved playlists, while swiping right or left navigates amongst parent approved content in an associated parent approved playlist. A child can select a background image 320A, 320B, 320C, 320D, 320E, 320F, 320G, 320H, or 320I, for example, using suitable touchscreen selection gesture, a non-limiting example of which includes, pressing on the touchscreen interface within a boundary of a background image for a predetermined amount of time. In response to selection of a background image, mode control component 150 can initiate playing or viewing of the playlist, for example, as depicted in FIGS. 3B and 3C.

Referring to FIG. 3B in a non-limiting example, client device 110 with child mode interface 305 is depicted where a child has selected background image 320E. In this example, viewing of the content in the playlist is delayed, for example due to processing, downloading, buffering delay of the content. As such, mode control component 150 can present an animation 325 in child mode interface 305 to keep the child occupied until the content is ready to be viewed. Example animation 325 depicts a puzzle animation made from background image 320E, however, any animation can be employed. When the content is ready for viewing, mode control component 150 can begin playing of the content, for example, as depicted in FIG. 3C. It is to be understood that playing an animation can be optional. In one example, child mode interface does not play an animation when playing of content is delayed. In another example, child mode interface selectively plays an animation, such as, based upon a device or user preference setting. In a further example, child mode interface always plays an animation when playing of content is delayed.

Referring to FIG. 3C in a non-limiting example, client device 110 with child mode interface 305 is depicted where a child has selected background image 320E. Mode control component 150 presents child mode interface 305 playing content associated with the playlist associated with background image 320E. Optionally, playback controls appropriate for the content can be presented. In this example, slider control 330A is shown that allows for selection of point of playback of the video content depicted. In addition, rewind control 330B, stop control 330C, pause control 330D, play control 330E, fast forward control 330F are depicted.

Additional controls (not depicted) can also be included, non-limiting examples of which include skip to next content in playlist, skip to previous content in playlist, exit playlist, skip to next playlist, or skip to previous playlist. Furthermore, mode control component 150 can limit navigation such that the child upon choosing to stop playing content or to exit a playlist is returned to a display of background images as depicted in FIG. 3A. Advantageously, this prevents the child from navigating from an application in which they were viewing parent approved content to an application, content, or function that is not approved by the parent. In a non-limiting example, child mode interface 305 can envelop any applications associated with content and limit the functionality of the application. For example, if a child is viewing a video, mode control component 150 can present a child mode interface 305 that envelops the video application and limit the functions of the video application to prevent navigating outside of the child mode interface.

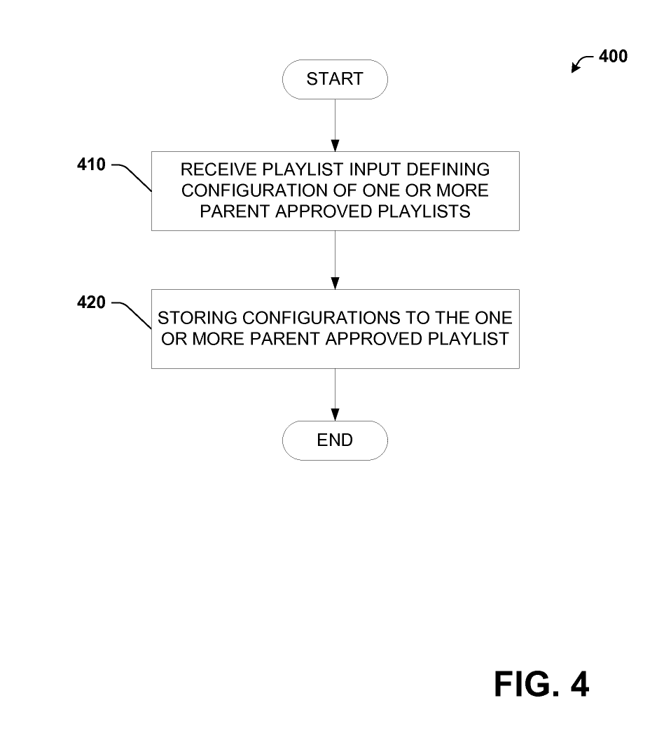

FIGS. 4-7 illustrate various methodologies in accordance with certain disclosed aspects. While, for purposes of simplicity of explanation, the methodologies are shown and described as a series of acts, it is to be understood and appreciated that the disclosed aspects are not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with certain disclosed aspects. Additionally, it is to be further appreciated that the methodologies disclosed hereinafter and throughout this disclosure are capable of being stored on an article of manufacture to facilitate transporting and transferring such methodologies to computers.

Referring to FIG. 4, an exemplary method 400 for configuring a parent approved playlist is depicted. At reference numeral 410, playlist input is received configuring content to include in a parent approved playlist or a background image to associate with a parent approved playlist. (e.g. by a content selection component 140 or suggestion component 160). It is to be appreciated that playlist input can be received for a plurality of parent approved playlists. It is further to be understood that a parent approved playlist can also be configured to remove previously included content, a playlist can be created, deleted, or modified, a previously associated background image can be disassociated from a parent approved playlist, and a playlist can be “Enabled for Kids” to make it a parent approved playlist. In addition, a parent approved playlist that has been “Enabled for Kids” can be disabled from viewing by children, so that it is no longer a parent approved playlist. At reference numeral 420, the configuration of the one or more parent approved playlists is stored (e.g. by a content selection component 140).

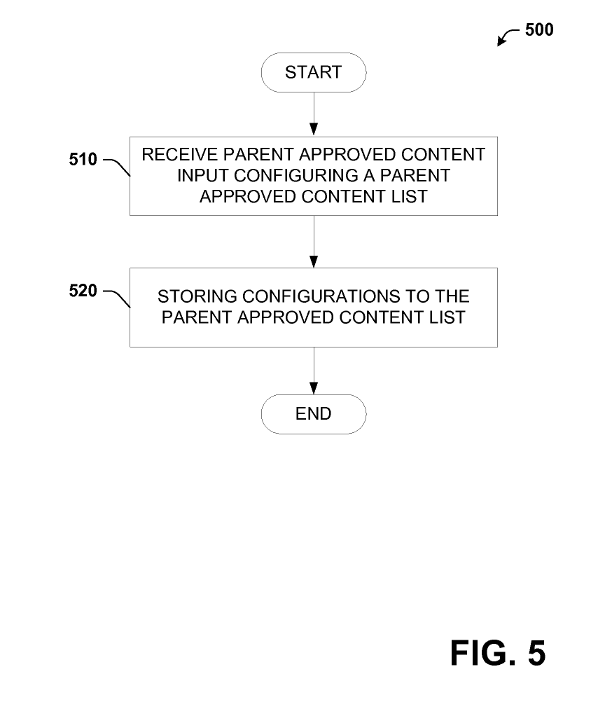

Referring to FIG. 5, an exemplary method 500 for configuring content in a parent approved content list 280 is depicted. At reference numeral 410, parent approved content input is received configuring content to include in a parent approved content list 280. (e.g. by a content selection component 140 or suggestion component 160). It is to be understood that a parent approved content list can be configured to add content or remove previously included content. At reference numeral 420, the configuration of the parent approved content list is stored (e.g. by a content selection component 140).

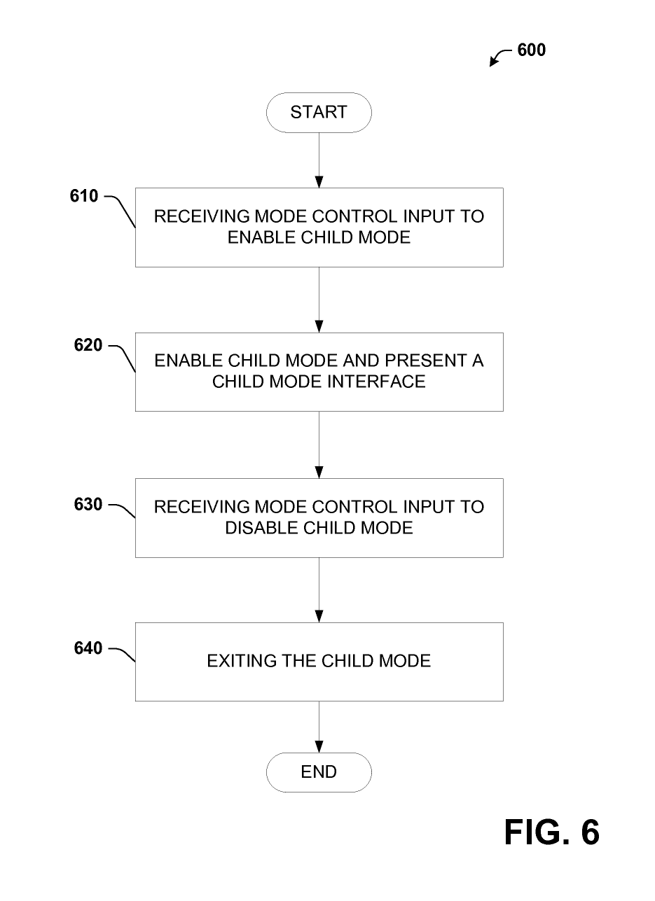

Referring to FIG. 6, an exemplary method 600 to enable or disable a child mode is depicted. At reference numeral 610, a mode control input is received to enable child mode on client device 110 (e.g. by a mode control component 150). At reference numeral 620, child mode is enable on client device 110 and a child mode interface 305 is presented (e.g. by a mode control component 150). At reference numeral 630, a mode control input is received to disable child mode on client device 110 (e.g. by a mode control component 150). At reference number 640, the child mode is exited on client device 110 and the child mode interface 305 is disabled (e.g. by a mode control component 150).

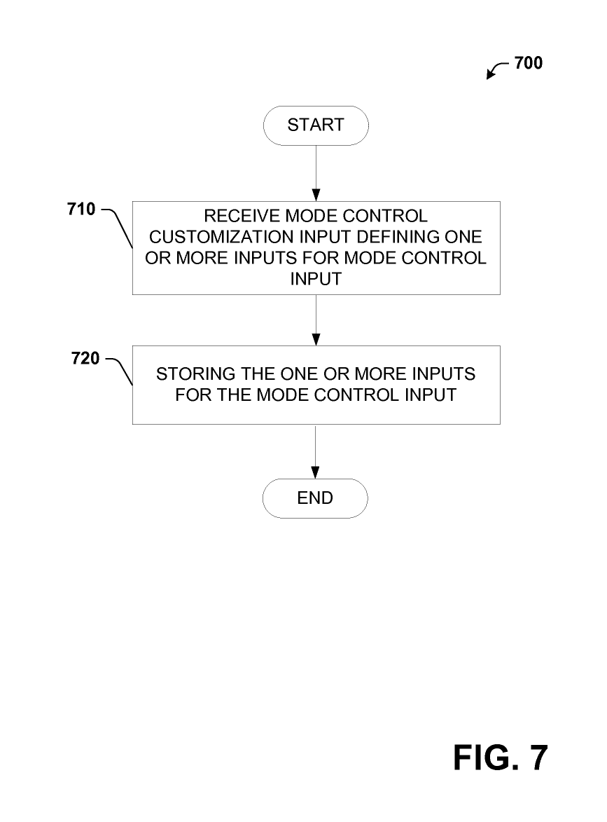

Referring to FIG. 7, an exemplary method 700 for defining mode control input to enable or disable child mode. At reference numeral 710, a mode control customization input is received that defines one or more inputs for the mode control input to enable or disable child mode on client device 110. (e.g. using a mode control component 150). At reference numeral 710, the one or more specified inputs for the mode control input are stored (e.g. using a mode control component 150).

### Exemplary Networked and Distributed Environments

One of ordinary skill in the art can appreciate that the various embodiments described herein can be implemented in connection with any computer or other client or server device, which can be deployed as part of a computer network or in a distributed computing environment, and can be connected to any kind of data store where media may be found. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services can also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the various embodiments of this disclosure.

FIG. 8 provides a schematic diagram of an exemplary networked or distributed computing environment. The distributed computing environment comprises computing objects 810, 812, etc. and computing objects or devices 820, 822, 824, 826, 828, etc., which may include programs, methods, data stores, programmable logic, etc., as represented by applications 830, 832, 834, 836, 838. It can be appreciated that computing objects 810, 812, etc. and computing objects or devices 820, 822, 824, 826, 828, etc. may comprise different devices, such as personal digital assistants (PDAs), audio/video devices, mobile phones, MP3 players, personal computers, laptops, tablets, etc.

Each computing object 810, 812, etc. and computing objects or devices 820, 822, 824, 826, 828, etc. can communicate with one or more other computing objects 810, 812, etc. and computing objects or devices 820, 822, 824, 826, 828, etc. by way of the communications network 840, either directly or indirectly. Even though illustrated as a single element in FIG. 8, network 840 may comprise other computing objects and computing devices that provide services to the system of FIG. 8, and/or may represent multiple interconnected networks, which are not shown. Each computing object 810, 812, etc. or computing objects or devices 820, 822, 824, 826, 828, etc. can also contain an application, such as applications 830, 832, 834, 836, 838, that might make use of an API, or other object, software, firmware and/or hardware, suitable for communication with or implementation of various embodiments of this disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any suitable network infrastructure can be used for exemplary communications made incident to the systems as described in various embodiments herein.

Thus, a host of network topologies and network infrastructures, such as client/server, peer-to-peer, or hybrid architectures, can be utilized. The “client” is a member of a class or group that uses the services of another class or group. A client can be a computer process, e.g., roughly a set of instructions or tasks, that requests a service provided by another program or process. A client process may utilize the requested service without having to “know” all working details about the other program or the service itself.

In a client/server architecture, particularly a networked system, a client can be a computer that accesses shared network resources provided by another computer, e.g., a server. In the illustration of FIG. 8, as a non-limiting example, computing objects or devices 820, 822, 824, 826, 828, etc. can be thought of as clients and computing objects 810, 812, etc. can be thought of as servers where computing objects 810, 812, etc. provide data services, such as receiving data from client computing objects or devices 820, 822, 824, 826, 828, etc., storing of data, processing of data, transmitting data to client computing objects or devices 820, 822, 824, 826, 828, etc., although any computer can be considered a client, a server, or both, depending on the circumstances. Any of these computing devices may be processing data, or requesting transaction services or tasks that may implicate the techniques for systems as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network/bus 840 is the Internet, for example, the computing objects 810, 812, etc. can be Web servers, file servers, media servers, etc. with which the client computing objects or devices 820, 822, 824, 826, 828, etc. communicate via any of a number of known protocols, such as the hypertext transfer protocol (HTTP). Objects 810, 812, etc. may also serve as client computing objects or devices 820, 822, 824, 826, 828, etc., as may be characteristic of a distributed computing environment.

### Exemplary Computing Device

As mentioned, advantageously, the techniques described herein can be applied to any suitable device. It is to be understood, therefore, that handheld, portable and other computing devices and computing objects of all kinds are contemplated for use in connection with the various embodiments. Accordingly, the below computer described below in FIG. 9 is but one example of a computing device. Additionally, a suitable server can include one or more aspects of the below computer, such as a media server or other media management server components.

Although not required, embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 9 thus illustrates an example of a suitable computing system environment 900 in which one or aspects of the embodiments described herein can be implemented, although as made clear above, the computing system environment 900 is only one example of a suitable computing environment and is not intended to suggest any limitation as to scope of use or functionality. Neither is the computing environment 900 be interpreted as having any dependency or requirement relating to any one or combination of components illustrated in the exemplary operating environment 900.

With reference to FIG. 9, an exemplary computing device for implementing one or more embodiments in the form of a computer 910 is depicted. Components of computer 910 may include, but are not limited to, a processing unit 920, a system memory 930, and a system bus 922 that couples various system components including the system memory to the processing unit 920.

Computer 910 typically includes a variety of computer readable media and can be any available media that can be accessed by computer 910. The system memory 930 may include computer storage media in the form of volatile and/or nonvolatile memory such as read only memory (ROM) and/or random access memory (RAM). By way of example, and not limitation, system memory 930 may also include an operating system, application programs, other program modules, and program data.

A user can enter commands and information into the computer 910 through input devices 940, non-limiting examples of which can include a keyboard, keypad, a pointing device, a mouse, stylus, touchpad, touchscreen, trackball, motion detector, camera, microphone, joystick, game pad, scanner, or any other device that allows the user to interact with computer 910. A monitor or other type of display device is also connected to the system bus 922 via an interface, such as output interface 950. In addition to a monitor, computers can also include other peripheral output devices such as speakers and a printer, which may be connected through output interface 950.

The computer 910 may operate in a networked or distributed environment using logical connections to one or more other remote computers, such as remote computer 970. The remote computer 970 may be a personal computer, a server, a router, a network PC, a peer device or other common network node, or any other remote media consumption or transmission device, and may include any or all of the elements described above relative to the computer 910. The logical connections depicted in FIG. 9 include a network 972, such local area network (LAN) or a wide area network (WAN), but may also include other networks/buses e.g., cellular networks.

As mentioned above, while exemplary embodiments have been described in connection with various computing devices and network architectures, the underlying concepts may be applied to any network system and any computing device or system in which it is desirable to publish or consume media in a flexible way.

Also, there are multiple ways to implement the same or similar functionality, e.g., an appropriate API, tool kit, driver code, operating system, control, standalone or downloadable software object, etc. which enables applications and services to take advantage of the techniques described herein. Thus, embodiments herein are contemplated from the standpoint of an API (or other software object), as well as from a software or hardware object that implements one or more aspects described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the aspects disclosed herein are not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function (e.g., coding and/or decoding); software stored on a computer readable medium; or a combination thereof.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In order to provide for or aid in the numerous inferences described herein (e.g. inferring relationships between metadata or inferring topics of interest to users), components described herein can examine the entirety or a subset of the data to which it is granted access and can provide for reasoning about or infer states of the system, environment, etc. from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines, etc.) can be employed in connection with performing automatic and/or inferred action in connection with the claimed subject matter.

A classifier can map an input attribute vector, x=(x1, x2, x3, x4, xn), to a confidence that the input belongs to a class, as by f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

In view of the exemplary systems described above, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be effected across a plurality of devices. Accordingly, the invention is not to be limited to any single embodiment, but rather can be construed in breadth, spirit and scope in accordance with the appended claims.

1. A mobile device, comprising:
a touchscreen user input mechanism;
at least one other user input mechanism that is not touchscreen based;
a memory that has stored thereon computer executable components;
a microprocessor that executes the following computer executable components stored in the memory:
a content selection component configured to receive a playlist input specifying content to include in at least one parent approved playlist; and
a mode control component configured to selectively enable a child mode on the mobile device based upon mode control input, wherein the child mode disables the at least one other user input mechanism such that all user input to the mobile device must be made through the touchscreen user input mechanism, and displays a child mode interface that restricts access on the mobile device to the at least one parent approved playlist and the content in the at least one parent approved playlist.

2. The mobile device of claim 1, wherein the content includes at least one of video content or audio content.

3. The mobile device of claim 1, wherein the playlist input further comprises specifying a background image to associate with a parent approved playlist of the at least one parent approved playlist.

4. The mobile device of claim 1, wherein the content selection component is further configured to automatically generate a background image to associate with a parent approved playlist of the at least one parent approved playlist, wherein the background image is generated from at least one image included in content associated with the parent approved playlist.

5. The mobile device of claim 4, wherein the mode control component is further configured to display the background image associated with a parent approved playlist in the child mode interface.

6. The mobile device of claim 1, wherein the content selection component is further configured to receive parent approved content input specifying content to include in a list of parent approved content.

7. The mobile device of claim 1, further comprising a suggestion component configured to automatically build a parent approved playlist of the at least one parent approved playlist from a parent approved content list based upon an analysis of content viewed while in child mode.

8. The mobile device of claim 1, further comprising a suggestion component configured to automatically generate a suggested list of content for inclusion in the parent approved content list.

9. The mobile device of claim 8, wherein the suggestion component is further configured to generate the suggested list by searching available content for content similar to content specified in the playlist input.

10. The mobile device of claim 1, wherein the playlist input further comprises specifying at least one of a plurality of parent approved playlists as the at least one parent approved playlist to enable for access in the child mode.

11. The mobile device of claim 1, wherein the child mode disables the at least one other user input mechanism such that all user input to the mobile device must be made through the touchscreen user input mechanism with the exception of a predefined biometric user input recognizable by a biometric user input mechanism of the at least one other user input mechanism.

12. The mobile device of claim 1, wherein the mode control component is further configured to receive mode control customization input to define one or more touchscreen gestures for the mode control input that enables or disables the child mode.

13. A method, comprising:
receiving a playlist input at a mobile device specifying content to include in at least one parent approved playlist, wherein the mobile device comprises a touchscreen user input mechanism and at least one other user input mechanism that is not touchscreen based;
selectively enabling a child mode on the mobile device based upon mode control input, wherein the child mode disables the at least one other user input mechanism such that all user input to the mobile device must be made through the touchscreen user input mechanism, and displays a child mode interface that restricts access on the mobile device to the at least one parent approved playlist and the content in the at least one parent approved playlist.

14. The method of claim 13, wherein the content includes at least one of video content or content.

15. The method of claim 13, wherein the playlist input further comprises specifying a background image to associate with a parent approved playlist of the at least one parent approved playlist.

16. The method of claim 13, further comprising automatically generating a background image to associate with a parent approved playlist of the at least one parent approved playlist, wherein the background image is generated from at least one image included in content associated with the parent approved playlist.

17. The method of claim 15 or 16, further comprising displaying the background image associated with parent approved playlist in the child mode interface.

18. The method of claim 13, further comprising receiving parent approved content input specifying content to include in a list of parent approved content.

19. The method of claim 13, further comprising automatically building a parent approved playlist from a parent approved content list based upon an analysis of content viewed while in child mode.

20. The method of claim 13, further comprising generating a suggested list of content for inclusion in the parent approved content list.

21. The method of claim 20, further comprising generating the suggested list by searching available content for content similar to content specified in the playlist input.

22. The method of claim 13, wherein the playlist input further comprises specifying at least one of a plurality of parent approved playlists as the at least one parent approved playlist to enable for access in the child mode.

23. The method of claim 13, further comprising providing swipe navigation in the child mode interface that accepts touchscreen swipe gestures to at least one of navigate through parent approved playlists, navigate through content, select a parent approved playlist, or select content.

24. The method of claim 13, further comprising receiving mode control customization input to define one or more touchscreen gestures for the mode control input that enables or disables the child mode.

25. A system, comprising:
means for receiving a playlist input specifying content to include in at least one parent approved playlist;
means for selectively enabling a child mode on a client device based upon mode input, wherein the client device comprises a touchscreen user input mechanism and at least one other user input mechanism that is not touchscreen based, wherein the child mode disables the at least one other user input mechanism such that all user input to the client device must be made through the touchscreen user input mechanism, and displays a child mode interface that restricts access on the client device to the at least one parent approved playlist and the content in the at least one parent approved playlist.

26. A non-transitory computer-readable medium having instructions stored thereon that, in response to execution, cause at least one device to perform operations comprising:
receiving a playlist input specifying content to include in at least one parent approved playlist;
selectively enabling a child mode on a client device based upon mode input, wherein the client device comprises a touchscreen user input mechanism and at least one other user input mechanism that is not touchscreen based, wherein the child mode disables the at least one other user input mechanism such that all user input to the client device must be made through the touchscreen user input mechanism, and displays a child mode interface that restricts access on the client device to the at least one parent approved playlist and the content in the at least one parent approved playlist.
